(19) United States
(12) Patent Application Publication
(10) Pub. No.: US 2008/0204683 A1
(43) Pub. Date: Aug. 28, 2008

(54) Lithographic apparatus and method

(75) Inventor: Henricus Wilhelmus Maria Van Buel, Eindhoven (NL)

Correspondence Address: PILLSBURY WINTHROP SHAW PITTMAN, LLP, P.O. BOX 10500, MCLEAN, VA, 22102, US

(73) Assignee: ASML Netherlands B.V., Veldhoven (NL)

(21) Appl. No.: 11/710,620

(22) Filed: Feb. 26, 2007

(51) Int. Cl. G03B 27/42; G03B 27/52

(52) U.S. Cl. 355/53; 355/71; 355/77

(57) ABSTRACT

A lithographic apparatus includes an illumination system constructed and arrange to condition a beam of radiation, a patterning device constructed and arranged to pattern the beam of radiation, a projection system constructed and arranged to project the patterned beam of radiation onto a target portion of a substrate, a substrate table constructed and arranged to hold the substrate, and a shutter system constructed and arranged to selectively prevent at least part of the beam of radiation from passing through the projection system. The shutter system includes a first shutter element, and a rotatable second shutter element constructed and arranged to alternately allow and prevent passage of the radiation beam when rotated. The first shutter element and the rotatable second shutter element are not of identical structure.

### FIELD

The present invention relates to a lithographic apparatus and method.

### BACKGROUND

A lithographic apparatus is a machine that applies a desired pattern onto a target portion of a substrate. Lithographic apparatus can be used, for example, in the manufacture of integrated circuits (ICs). In that circumstance, a patterning device, which is alternatively referred to as a mask or a reticle, may be used to generate a circuit pattern corresponding to an individual layer of the IC, and this pattern can be imaged onto a target portion (e.g. comprising part of, one or several dies) on a substrate (e.g. a silicon wafer) that has a layer of radiation-sensitive material (resist). In general, a single substrate will contain a network of adjacent target portions that are successively exposed. Known lithographic apparatus include so-called steppers, in which each target portion is irradiated by exposing an entire pattern onto the target portion in one go, and so-called scanners, in which each target portion is irradiated by scanning the pattern through the beam in a given direction (the “scanning”-direction) while synchronously scanning the substrate parallel or anti-parallel to this direction.

In existing lithographic apparatuses, a shutter system is provided to prevent radiation from a radiation source from passing through the lithographic apparatus, for example, when irradiation of a target portion of the substrate is not required. In some circumstances, it may be necessary to quickly open and/or close shutters of the shutter system, or to repeatedly open and close the shutters of the shutter system., to ensure that radiation passes through the lithographic apparatus for a short period of time (i.e. for a short period of irradiation) If the shutters of the shutter systems are heavy, it can be difficult or impossible to open and/or close the shutters in a period of time which is short enough to ensure that the exposure time is sufficiently short.

It is therefore desirable to provide, for example, a lithographic apparatus and method to obviate or mitigate one or more of the problems of the prior art, whether identified herein or elsewhere.

### SUMMARY

According to an aspect of the present invention, there is provided a lithographic apparatus. The lithographic apparatus includes an illumination system constructed and arrange to condition a beam of radiation, a patterning device constructed and arranged to pattern the beam of radiation, a projection system constructed and arranged to project the patterned beam of radiation onto a target portion of a substrate, a substrate table constructed and arranged to hold the substrate, and a shutter system constructed and arranged to selectively prevent at least part of the beam of radiation from passing through the projection system. The shutter system includes a first shutter element, and a rotatable second shutter element constructed and arranged to alternately allow and prevent passage of the radiation beam when rotated. The first shutter element and the rotatable second shutter element are not of identical structure.

According to a further aspect of the present invention, there is provided a lithographic method. The method includes patterning a beam of radiation with a patterning device of a lithographic apparatus; projecting the patterned radiation beam onto a target portion of a substrate; moving a moveable shutter element to selectively allow or prevent passage of the beam of radiation to a rotatable shutter element; and continuously rotating the rotatable shutter element to alternately allow and prevent passage of the beam of radiation to one or more other parts of the lithographic apparatus.

According to a yet further aspect of the present invention, there is provided a lithographic method. The method includes patterning a beam of radiation with a patterning device of a lithographic apparatus; projecting the patterned beam of radiation onto a target portion of a substrate; continuously rotating a rotatable shutter element to alternately allow and prevent passage of the beam of radiation to a moveable shutter element; and moving the moveable shutter element to selectively allow or prevent passage of the beam of radiation to one or more other parts of the lithographic apparatus.

### BRIEF DESCRIPTION OF THE DRAWINGS

Embodiments of the invention will now be described, by way of example only, with reference to the accompanying schematic Figures in which corresponding reference symbols indicate corresponding parts, and in which:

FIG. 1 depicts a lithographic apparatus according to an embodiment of the invention;

FIGS. 2a to 2c depict a shutter system provided in the lithographic apparatus of FIG. 1;

FIGS. 3a to 3c depict operating principles of the shutter system of FIGS. 2a to 2c; and

FIGS. 4a to 4c depict operating principles of the shutter system of FIGS. 2a to 2c.

### DETAILED DESCRIPTION

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of 436, 405, 365, 248, 193, 157 or 126 nm) and extreme ultra-violet (EUV) radiation (e.g. having a wavelength in the range of 5-20 nm), as well as particle beams, such as ion beams or electron beams.

The term “patterning device” used herein should be broadly interpreted as referring to a device that can be used to impart a radiation beam with a pattern in its cross-section such as to create a pattern in a target portion of the substrate. It should be noted that the pattern imparted to the radiation beam may not exactly correspond to the desired pattern in the target portion of the substrate. Generally, the pattern imparted to the radiation beam will correspond to a particular functional layer in a device being created in the target portion, such as an integrated circuit.

A patterning device may be transmissive or reflective. Examples of a patterning device include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned.

The support structure holds the patterning device. It holds the patterning device in a way depending on the orientation of the patterning device, the design of the lithographic apparatus, and other conditions, such as for example whether or not the patterning device is held in a vacuum environment. The support can use mechanical clamping, vacuum, or other clamping techniques, for example electrostatic clamping under vacuum conditions. The support structure may be a frame or a table, for example, which may be fixed or moveable as needed and which may ensure that the patterning device is at a desired position, for example with respect to the projection system. Any use of the terms “reticle” or “mask” herein may be considered synonymous with the more general term “patterning device”.

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Any use of the term “projection lens” herein may be considered as synonymous with the more general term “projection system”.

The illumination system may also encompass various types of optical components, including refractive, reflective, and catadioptric optical components for directing, shaping, or controlling the beam of radiation, and such components may also be referred to below, collectively or singularly, as a “lens”.

The lithographic apparatus may be of a type having two (dual stage) or more substrate tables (and/or two or more support structures). In such “multiple stage” machines the additional tables may be used in parallel, or preparatory steps may be carried out on one or more tables while one or more other tables are being used for exposure.

The lithographic apparatus may also be of a type wherein the substrate is immersed in a liquid having a relatively high refractive index, e.g. water, so as to fill a space between the final element of the projection system and the substrate. Immersion liquids may also be applied to other spaces in the lithographic apparatus, for example, between the mask and the first element of the projection system. Immersion techniques are well known in the art for increasing the numerical aperture of projection systems.

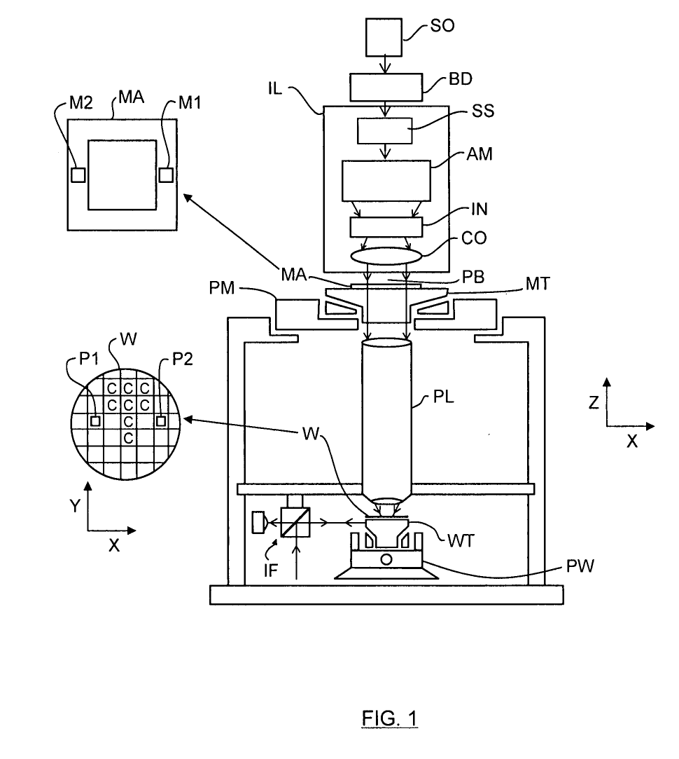

FIG. 1 schematically depicts a lithographic apparatus according to an embodiment of the invention. The apparatus comprises an illumination system (illuminator) IL to condition a beam PB of radiation (e.g. UV radiation or DUV radiation); a support structure (e.g. a mask table) MT to support a patterning device (e.g. a mask) MA and connected to a first positioning device PM to accurately position the patterning device with respect to item PL; a substrate table (e.g. a wafer table) WT for holding a substrate (e.g. a resist-coated wafer) W and connected to a second positioning device PW for accurately positioning the substrate W with respect to item PL; a projection system (e.g. a refractive projection lens) PL configured to image a pattern imparted to the radiation beam PB by patterning device MA onto a target portion C (e.g. comprising one or more dies) of the substrate W; and a shutter system SS for selectively preventing at least a part of the radiation beam from passing onto or through elements of the lithographic apparatus.

As here depicted, the apparatus is of a transmissive type (e.g. employing a transmissive mask). Alternatively, the apparatus may be of a reflective type (e.g. employing a programmable mirror array of a type as referred to above).

The illuminator IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising for example suitable directing mirrors and/or a beam expander. In other cases the source may be an integral part of the apparatus, for example when the source is a mercury lamp. The source SO and the illuminator IL, together with the beam delivery system BD if required, may be referred to as a radiation system.

The illuminator IL may comprise an adjustor AM for adjusting the angular intensity distribution of the beam. Generally, at least the outer and/or inner radial extent (commonly referred to as (-outer and (-inner, respectively) of the intensity distribution in a pupil plane of the illuminator can be adjusted. In addition, the illuminator IL generally comprises various other components, such as an integrator IN and a condenser CO. The illuminator provides a conditioned beam of radiation PB, having a desired uniformity and intensity distribution in its cross-section.

The radiation beam PB is incident on the patterning device (e.g. mask) MA, which is held on the support structure MT. Having traversed the patterning device MA, the beam PB passes through the lens PL, which focuses the beam onto a target portion C of the substrate W. With the aid of the second positioning device PW and position sensor IF (e.g. an interferometric device), the substrate table WT can be moved accurately, e.g. so as to position different target portions C in the path of the beam PB. Similarly, the first positioning device PM and another position sensor (which is not explicitly depicted in FIG. 1) can be used to accurately position the patterning device MA with respect to the path of the beam PB, e.g. after mechanical retrieval from a mask library. In general, movement of the object tables MT and WT will be realized with the aid of a long-stroke module (coarse positioning) and a short-stroke module (fine positioning), which form part of the positioning device PM and PW. However, in the case of a stepper (as opposed to a scanner) the support structure MT may be connected to a short stroke actuator only, or may be fixed. Patterning device MA and substrate W may be aligned using patterning device alignment marks M1, M2 and substrate alignment marks P1, P2.

The depicted apparatus can be used, for example, in the following modes:

1. In step mode, the support structure MT and the substrate table WT are kept essentially stationary, while an entire pattern imparted to the beam PB is projected onto a target portion C in one go (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the beam PB is projected onto a target portion C (i.e. a single dynamic exposure). The velocity and direction of the substrate table WT relative to the support structure MT is determined by the (de-) magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the beam PB is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

In prior lithographic apparatuses, a shutter system is provided which comprises one or more shutters which are moveable into and out of the path of a radiation beam. For example, the time for which a target portion of a substrate is exposed to radiation (i.e. the exposure time) can be controlled by opening the shutters (therefore allowing the radiation beam to pass) for a desired time. If the exposure time is short, it may be necessary to quickly open and close the shutters, often in a repetitious manner. If it is not possible to move the shutters quickly enough, it may be impossible to achieve sufficiently short exposure times below. Specifically, the exposure times will be limited by the time taken to open/close the shutters.

In some lithographic apparatuses, the radiation beam used to pattern substrates is very intense and/or comprises highly energetic photons. Such an intense or highly energetic radiation beam generates a lot of heat which can, over time, damage or even burn through the blades of the shutter system. For this reason, the blades of the shutter system are often ‘heavy duty’, in that they are thick, or formed from a dense material to slow down or prevent the degrading effect of the radiation beam. Since the blades of the shutter system are thick and/or formed from a dense material, they are generally cumbersome (e.g. heavy), and are therefore difficult to move quickly. Since it is difficult to move the blades quickly, it becomes difficult or impossible to achieve short exposure times.

Referring to FIG. 1, a lithographic apparatus according to an embodiment of the present invention is shown. In FIG. 1 the shutter system SS is shown in the illuminator IL and before (or above as shown in the Figure) the adjustor AM. It will, however, be appreciated that the shutter system SS may be located in any suitable part of the lithographic apparatus, and in particular in any suitable part of the illuminator IL. For example, the shutter system SS may be provided between the adjustor AM and the integrator IN, between the integrator IN and the condenser CO, or between the condenser CO and the patterning device MA. The shutter system SS may be located before the integrator IN, so as to reduce or eliminate the possibility of introducing non-uniformities in the, for example, cross section of the radiation beam. The shutter system SS is also shown schematically as a box in FIG. 1. It will, however, be appreciated that the components of the shutter system SS may be appropriately located throughout the illuminator IL. For example, one or more parts (e.g. shutters) of the shutter system may be located between the beam delivery system BD and the adjustor AM, whereas other masking parts of the shutter system maybe provided, for example, between the condenser CO and the patterning device MA. As will be appreciated by one skilled in the art, the shutter system SS maybe configured in any appropriate manner.

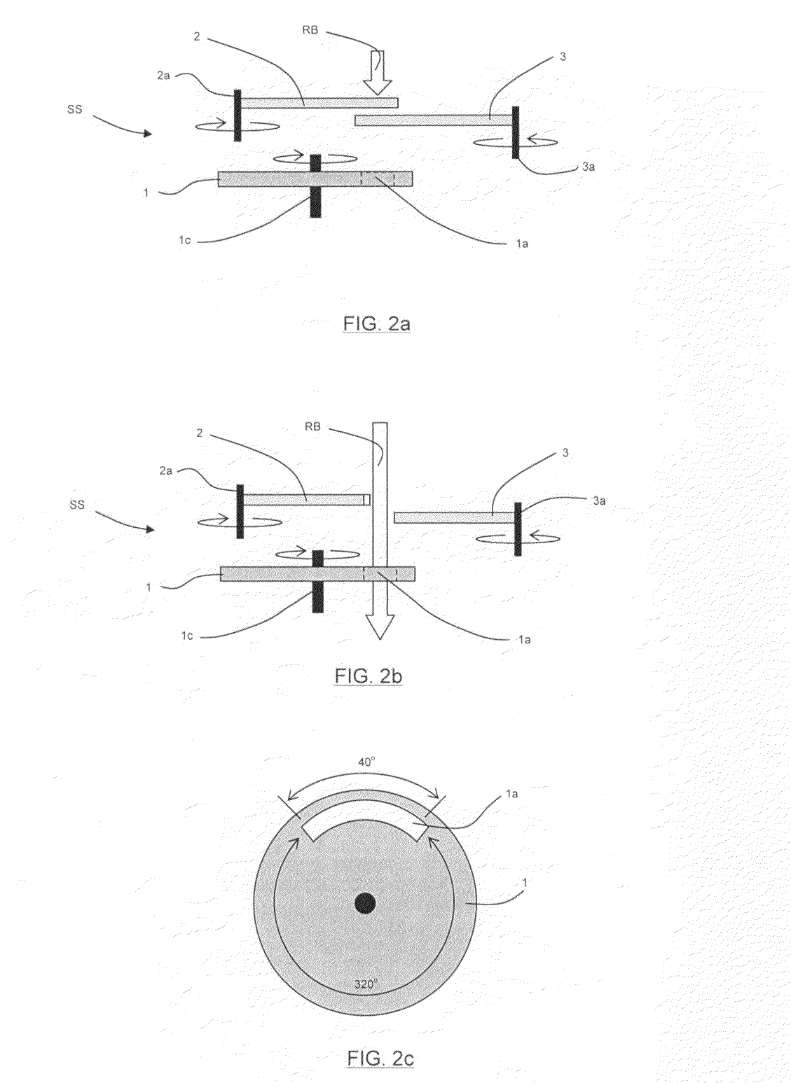

FIGS. 2a to 2c show the shutter system SS of FIG. 1 in more detail. The shutter system SS according to an embodiment of the present invention comprises a rotatable disc 1 (which serves as a rotatable shutter element) and two moveable shutter elements 2, 3 (hereinafter referred to as “moveable shutter elements 2, 3”). The rotatable disc 1 is located below (or, in other words, after) the moveable shutter elements 2, 3. The rotatable disc 1 is provided with an aperture 1a. The aperture 1a is arc-shaped, and the radius of curvature of the arc-shaped aperture 1a is centered on the center of the rotatable disc 1.

The moveable shutter elements 2, 3 are moveable from a first configuration, where they prevent a radiation beam RB (e.g. the radiation beam provided by the source SO of FIG. 1) from passing onto the rotatable disc 1, to a second configuration, where they allow the radiation beam RB to pass onto the rotatable disc 1. The moveable shutter elements 2, 3 may be appropriately positioned by suitable rotation about rotational axes 2a, 3a. It will be appreciated that, instead of being rotatable, the moveable shutter elements 2, 3 could be arranged to move linearly to prevent passage of a part of or the entire radiation beam RB. It will also be appreciated that only a single shutter may be desired in some circumstances.

The moveable shutter elements 2, 3 are made from a heavy duty material which is resistant to damage (e.g. from heat, etc.) caused by the radiation beam RB. In some embodiments, the moveable shutter elements 2, 3 may be made from a reflective material to reflect heat and/or radiation away and reduce or prevent damage to the moveable shutter elements 2, 3. In other embodiments, the moveable shutter elements 2, 3 may be made from a material which absorbs the radiation (or heat), in order to prevent radiation (or heat) being reflected to other parts of the lithographic apparatus.

The rotatable disc 1 maybe rotated about an axis 1c which extends through the center of the rotatable disc 1 to bring the aperture 1a into alignment with the radiation beam RB. Apart from the aperture 1a, the rotatable disc 1 is opaque to a radiation beam RB. In some embodiments, the rotatable disc 1 may be made from a reflective material to reflect heat (or radiation) away from and reduce or prevent damage to the rotatable disc 1. In other embodiments, the rotatable disc 1 may be made from a material which absorbs the radiation (or heat), in order to prevent radiation (or heat) being reflected to other parts of the lithographic apparatus.

In an embodiment, the moveable shutter and/or the rotatable shutter is made of a metal, e.g. aluminum or steel. The movable shutter and/or the rotatable shutter may be coated, e.g. with a reflective or absorbing coating. Also, an oxide layer may be provided on the shutter (e.g. a Si oxide layer).

FIG. 2a shows the moveable shutter elements 2, 3 in their first configuration, where they prevent the radiation beam RB from passing onto the rotatable disc 1. When the moveable shutter elements 2, 3 are in this configuration, it does not matter what position the rotatable disc 1 is in, since no the radiation beam RB is not allowed to pass onto it.

FIG. 2b shows the moveable shutter elements 2, 3 in their second configuration, where they allow the radiation beam RB to pass onto the rotatable disc 1. When the moveable shutter elements 2, 3 are in this configuration, the position of the rotatable disc 1 determines whether the radiation beam RB is passed onto further parts of the lithographic apparatus, for example the adjustor AM or integrator IN of FIG. 1. It can be seen from FIG. 2b that rotation of the rotatable disc I has brought the aperture la of the rotatable disc 1 into alignment with the radiation beam RB. This allows the radiation beam RB to pass through the rotatable disc 1.

FIG. 2c shows the rotatable disc 1 of FIGS. 2a and 2b in plan view. It can be seen that the aperture 1a extends in an arc (40°) about the center of the rotatable disc 1. The length of the arc which defines the aperture la defines the time for which the radiation beam RB may pass through the aperture 1a (for a given speed of rotation of the rotatable disc 1). It will therefore be appreciated that the time for which the radiation beam RB extends through the aperture 1a can be controlled by either varying the degree by which the aperture 1a extends around the center of the rotating disc 1 (e.g. by changing the disc) or by changing the rotational speed of the rotatable disc 1.

The use of the rotatable disc 1 is particularly advantageous. When the moveable shutter elements 2, 3 are in there second or open configuration, the time for which the radiation beam RB passes through the rotatable disc 1 (i.e. the exposure time) can be controlled by choosing an appropriately shaped aperture and rotating speed of the rotatable disc 1. When the radiation beam RB is not aligned with and passing through the aperture la of the rotatable disc 1, the radiation beam RB is instead being prevented from passing onto other parts of the lithographic apparatus (for example the adjustor AM or integrator IN of FIG. 1) by the solid (and opaque) areas of the rotatable disc 1 (i.e. the 320° region of the rotatable disc 1 not forming part of the 40° aperture 1a). So, even if the moveable shutters 2, 3 are heavy, and are thus difficult to move quickly, the inclusion of the rotatable disc 1 in the shutter system SS overcomes the problems of the prior art. This is because rotation of the rotatable disc 1 determines the exposure time, and not movement of the cumbersome moveable shutter elements 2, 3. The rotatable disc 1 rotates in one direction, and it does not therefore matter if the rotatable disc 1 is heavy (in order to resist damage from the radiation beam RB). This is because no changes in the direction of rotation of the rotatable disc 1, and therefore large changes in momentum, are needed. Further advantages of the incorporation of the rotatable disc 1 are explained below.

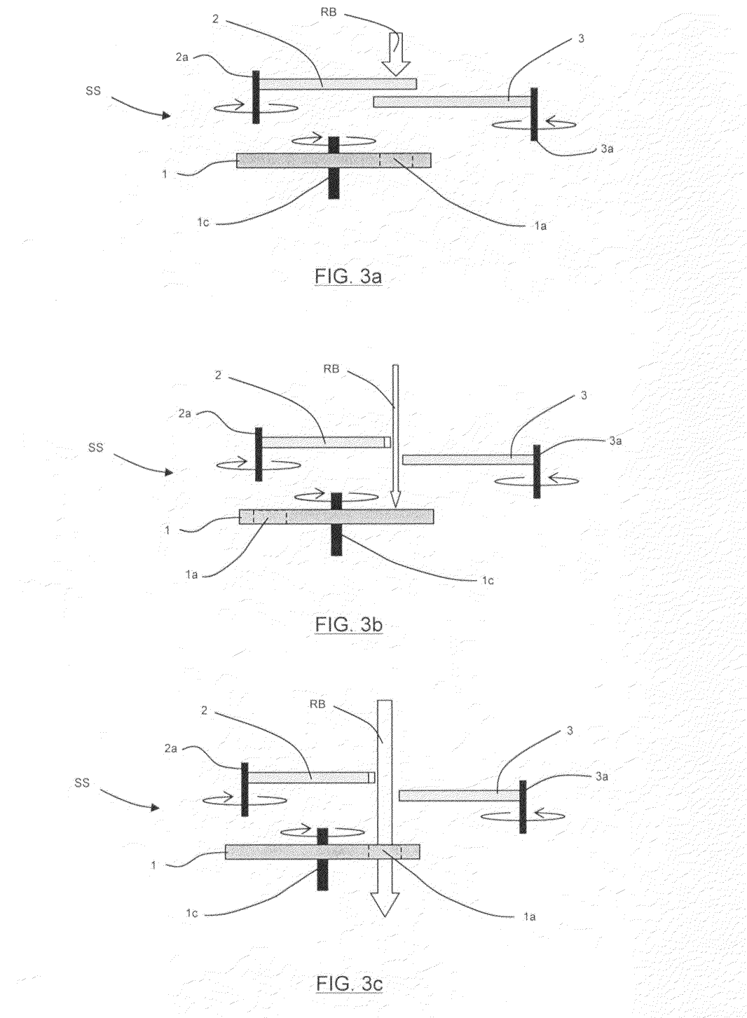

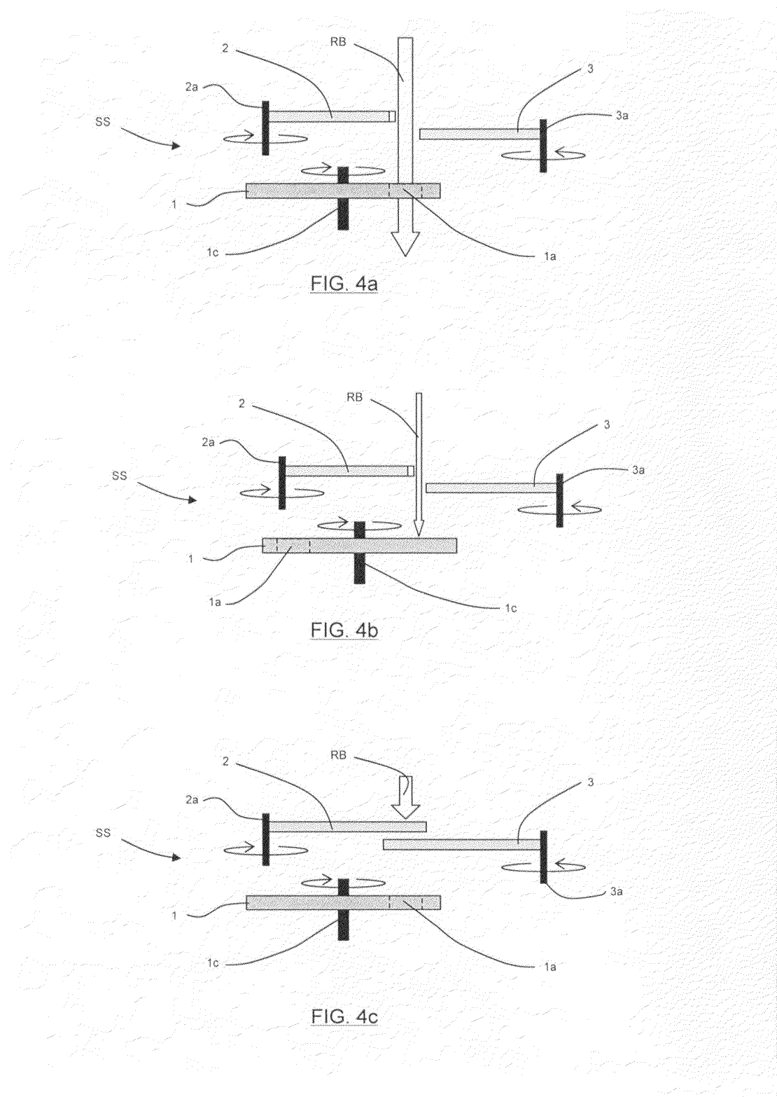

FIGS. 3a to 3c and 4a to 4c illustrate operating principles of the shutter system SS according to an embodiment of the present invention.

FIG. 3a shows the moveable shutter elements 2, 3 in their first or closed configuration. The rotatable disc 1 is rotating continuously at a constant, predetermined speed. At equal intervals therefore, the aperture 1a is brought into alignment with the radiation beam RB. However, because the moveable shutter elements 2, 3 are closed, the radiation beam RB is unable to pass onto the rotatable disc 1 and through the aperture 1a.

FIG. 3b illustrates the situation as the moveable shutter elements 2, 3 are being moved to their second or open configuration. A part of the radiation beam RB is able to pass in-between the moveable shutter element 2, 3 and onto the rotatable disc 1. At this point in time, however, the aperture 1a of the rotatable disc 1 has been rotated out of alignment with the radiation beam RB. This means that the radiation beam RB cannot pass through the rotatable disc 1 and onto other parts of the lithographic apparatus (for example the adjustor AM or integrator IN of FIG. 1). The time for which the aperture 1a has been rotated out of alignment with the radiation beam RB can therefore be used to fully open the moveable shutter elements 2, 3. At the same time, the substrate W of FIG. 1 could be moved to a position ready for a static or scanned exposure of a desired target region.

FIG. 3c illustrates the situation when the moveable shutter elements 2, 3 have been moved to their second or open configuration. The entire cross section of the radiation beam RB may now pass in between the moveable shutters elements 2, 3 and onto the rotatable disc 1. Just after the moveable shutter elements 2, 3 have been moved to their second or open configuration, the aperture 1 a of the rotating rotatable disc 1 is rotated into alignment with the radiation beam RB. This means that the radiation beam RB can pass through the rotatable disc 1 and onto other parts of the lithographic apparatus (for example the adjustor AM or integrator IN of FIG. 1). The time for which the radiation beam RB passes through the aperture 1a is dictated by the size and shape of the aperture 1a, as well as the speed at which the rotatable disc rotates. As mentioned above, therefore, the rotation of the aperture 1a through the radiation beam RB dictates the exposure time, for example of a static or scanned exposure of a target region of a substrate.

In summary, FIGS. 3a to 3c show that the moveable shutter elements 2, 3 and rotatable disc 1 are used in combination to determine firstly if an exposure is to undertaken, and secondly how long that exposure will be. The moveable shutter elements 2, 3 no longer determine the exposure time, which means that they can be moved to a desired (e.g. open) configuration while the rotatable disc 1 has been rotated to prevent the radiation beam RB from passing through it.

FIGS. 4a to 4c illustrate the opposite situation to that illustrated in FIGS. 3a to 3c. FIG. 4a illustrates the situation when the moveable shutter elements 2, 3 have been moved to their second or open configuration. The entire cross section of the radiation beam RB may pass in-between the moveable shutters elements 2, 3 and onto the rotatable disc 1. The rotatable disc 1 is rotating continuously at a constant pre-determined speed, and just after the moveable shutter elements 2, 3 have been moved to their second or open configuration, the aperture 1a of the rotatable disc 1 is rotated into alignment with the radiation beam RB. This means that the radiation beam RB can pass through the rotatable disc 1 and onto other parts of the lithographic apparatus (for example the adjustor AM or integrator IN of FIG. 1). The time for which the radiation beam RB passes through the aperture 1a is dictated by the size and shape of the aperture 1a, as well as the speed at which the rotatable disc rotates. As mentioned above, therefore, the rotation of the aperture 1a through the radiation beam RB dictates the exposure time, for example of a static or scanned exposure of a target region of a substrate.

FIG. 4b illustrates the situation as the moveable shutter elements 2, 3 are being moved to their first or closed configuration. A part of the radiation beam RB is able to pass in-between the moveable shutter element 2, 3 and onto the rotatable disc 1. At this point in time, however, the aperture 1a of the rotatable disc 1 has been rotated out of alignment with the radiation beam RB. This means that the radiation beam RB cannot pass through the rotatable disc 1 and onto other parts of the lithographic apparatus (for example the adjustor AM or integrator IN of FIG. 1). The time for which the aperture 1a has been rotated out of alignment with the radiation beam RB can therefore be used to close the moveable shutter elements 2, 3. At the same time, the substrate W of FIG. 1 could be moved to a position ready for a static or scanned exposure of a desired target region.

FIG. 4c shows the moveable shutter elements 2, 3 in their first or closed positions. Because the moveable shutter elements 2, 3 are closed, the radiation beam RB is unable to pass onto the rotatable disc 1 and through the aperture 1a.

In summary, FIGS. 4a to 4c show that the moveable shutter elements 2, 3 and rotatable disc 1 are used in combination to determine firstly if an exposure is to undertaken, and secondly how long that exposure will be. The moveable shutter elements 2, 3 no longer determine the exposure time, which means that they can be moved to a desired (e.g. closed) configuration while the rotatable disc 1 has been rotated to prevent the radiation beam RB from passing through it.

FIGS. 3 and 4 may be undertaken in sequence, from when the moveable shutter elements 2, 3 are closed in FIG. 3a, back to when they are closed in FIG. 4c. When the moveable shutter elements 2, 3 are closed, the substrate W of FIG. 1 may be moved to a position ready for exposure of a different target region. Alternatively, and as described previously, the substrate W may be moved when the aperture la of the rotatable disc 1 has been rotated out of alignment with the radiation beam RB.

By, for example, continuously rotating the rotatable disc 1, a pulsed radiation beam is created, and some or all of the times for which the aperture 1a is brought into alignment with the radiation beam RB can be used to successively expose different target regions of the substrate W. Similarly, some or all of the times when the aperture 1a is moved out of alignment with the radiation beam RB can be used to move the substrate W from a first position to a second position, so that the radiation beam RB maybe projected onto different target regions of the substrate W.

It will be appreciated that there are many variables which will affect the time for which a given radiation beam RB can pass through the rotatable disc 1. For example, the size of the aperture I a will be important, specifically the degree to which the aperture 1 a extends around the center of the rotatable disc 1. Similarly, the position of the aperture on the disc 1 will be important, together with the rotational speed of the disc 1. By choosing these variables carefully, the time for which the radiation beam RB passes through the aperture 1a (i.e. exposure time) can be carefully controlled. For example, the exposure time can be less than 200 milliseconds, for example 140 milliseconds or 25 milliseconds. The exposure time can be controlled automatically by changing the speed of rotation of the rotatable disc 1. Alternatively, the rotatable disc 1 may be interchangeable with other rotatable discs I having different properties (i.e. aperture sizes) to affect the exposure time.

It will be appreciated that the shape of the a rotatable shutter element 1 and aperture 1 a are not limited to the disc and arc shape described above. The shutter element 1 should be rotatable and configured to selectively allow or prevent the passage of radiation through the element. For example, the rotatable shutter element could be square or an elliptical in shape. The aperture 1a of the rotatable disc mentioned above could be replaced with a notch cut out from the periphery of the rotatable shutter element. An arc-shaped aperture may be preferable in some circumstances, since such an aperture defines clean straight edges at its ends, and a uniform thickness along its length. Therefore, the shape of the aperture through which the radiation beams passes is uniform during rotation of the rotatable shutter element. A plurality of apertures and/or notches could be provided in the rotatable element.

It will be appreciated that the rotatable disc 1 could be located before (or, in other words, above) the moveable shutter elements 2, 3. In this arrangement, the rotatable disc may need to be made from a more heavy duty material (e.g. one resistant to damage to UV radiation). However, and as mentioned above, this should not be a problem given that the rotatable disc 1 rotates continuously in one direction. No changes in the direction of rotation (and therefore large changes in momentum) are needed, and so exposure times would not be affected if the rotatable disc 1 was, for example, heavier.

In FIGS. 3 and 4, the moveable shutters 2, 3 are described as being moved when the aperture 1 a of the rotatable disc has been moved out of alignment with the radiation beam RB. This is to ensure that the area exposed by the radiation beam (for example the area of the patterning device MA or substrate W) is uniform, and does not change for a given exposure.

An additional shutter or a set of shutters (often referred to as blades) may be incorporated to mask off parts of the patterning device MA from the radiation beam. These additional shutters are normally located adjacent to the patterning device, and may be used to ensure that only certain parts (or parts of patterns) of the patterning device are projected onto a target region or target regions of the substrate.

The apparatus and methods described above can be used to determine the exposure times for static (i.e. stepped) exposure or moving (i.e. scanned exposures).

The lithographic apparatus depicted in FIG. 1 shows a transmissive patterning device MA, but the invention as claimed is equally applicable to other patterning device, for example reflective patterning devices.

While specific embodiments of the invention have been described above, it will be appreciated that the invention may be practiced otherwise than as described. The description is not intended to limit the invention.

What is claimed is:

1. A lithographic apparatus comprising:
an illumination system constructed and arrange to condition a beam of radiation;
a patterning device constructed and arranged to pattern the beam of radiation;
a projection system constructed and arranged to project the patterned beam of radiation onto a target portion of a substrate;
a substrate table constructed and arranged to hold the substrate; and
a shutter system constructed and arranged to selectively prevent at least part of the beam of radiation from passing through the projection system, the shutter system comprising
a first shutter element, and
a rotatable second shutter element constructed and arranged to alternately allow and prevent passage of the radiation beam when rotated,
wherein the first shutter element and the rotatable second shutter element are not of identical structure.

2. A lithographic apparatus as claimed in claim 1, wherein the shutter system is located within the illumination system.

3. A lithographic apparatus as claimed in claim 1, wherein the rotatable second shutter element is provided with an aperture constructed and arranged to allow passage of the beam of radiation when the beam of radiation is aligned with the aperture during rotation of the rotatable second shutter element.

4. A lithographic apparatus as claimed in claim 3, wherein the aperture is arc-shaped.

5. A lithographic apparatus as claimed in claim 4, wherein the radius of curvature of the arc shaped aperture is centered on the center of the rotatable second shutter element.

6. A lithographic apparatus as claimed in claim 1, wherein the rotatable second shutter element is provided with a notch constructed and arranged to allow passage of the beam of radiation when the beam of radiation is aligned with the notch during rotation of the rotatable second shutter element.

7. A lithographic apparatus as claimed in claim 1, wherein the rotatable second shutter element is disc-shaped.

8. A lithographic apparatus as claimed in claim 1, wherein the rotatable second shutter element is rotatable about an axis extending through its center.

9. A lithographic apparatus as claimed in claim 1, wherein the rotatable second shutter element is made from a material that reflects heat or radiation.

10. A lithographic apparatus as claimed in claim 1, wherein the rotatable second shutter element is made from a material that absorbs heat or radiation.

11. A lithographic apparatus as claimed in claim 1, wherein the first shutter element is made from a material that reflects heat or radiation.

12. A lithographic apparatus as claimed in claim 1, wherein the first shutter element is made from a material that absorbs heat or radiation.

13. A lithographic apparatus as claimed in claim 1, wherein the first shutter element is rotatable.

14. A lithographic apparatus as claimed in claim 1, wherein the first shutter element is linearly moveable.

15. A lithographic apparatus as claimed in claim 1, wherein the lithographic apparatus is a stepper lithographic apparatus.

16. A lithographic apparatus as claimed in claim 1, wherein the lithographic apparatus is a scanner lithographic apparatus.

17. The lithographic apparatus as claimed in claim 1, further comprising a radiation source comprising a mercury lamp.

18. The lithographic apparatus as claimed in claim 1, wherein the first shutter element is arranged to receive the beam of radiation before the rotatable second shutter element.

19. The lithographic apparatus as claimed in claim 1, wherein the first shutter element is arranged to receive the beam of radiation after the rotatable second shutter element.

20. A lithographic method comprising:
patterning a beam of radiation with a patterning device of a lithographic apparatus;
projecting the patterned radiation beam onto a target portion of a substrate;
moving a moveable shutter element to selectively allow or prevent passage of the beam of radiation to a rotatable shutter element; and
continuously rotating the rotatable shutter element to alternately allow and prevent passage of the beam of radiation to one or more other parts of the lithographic apparatus.

21. The lithographic method as claimed in claim 20, further comprising moving the substrate when the rotatable shutter element has been rotated to prevent passage of the beam of radiation.

22. The lithographic method as claimed in claim 20, further comprising moving the substrate from a first position to a second position when the moveable shutter element has been moved to prevent passage of the beam of radiation.

23. The lithographic method as claimed in claim 20, wherein the other parts include an integrator.

24. The lithographic method as claimed in claim 20, wherein the rotatable shutter element is rotated at a predetermined speed.

25. A lithographic method comprising:
patterning a beam of radiation with a patterning device of a lithographic apparatus;
projecting the patterned beam of radiation onto a target portion of a substrate;
continuously rotating a rotatable shutter element to alternately allow and prevent passage of the beam of radiation to a moveable shutter element; and
moving the moveable shutter element to selectively allow or prevent passage of the beam of radiation to one or more other parts of the lithographic apparatus.
